(19) United States
(12) Patent Application Publication
(10) Pub. No.: US 2010/0238184 A1
(43) Pub. Date: Sep. 23, 2010

(54) METHOD AND APPARATUS FOR THREE-DIMENSIONAL VISUALIZATION IN MOBILE DEVICES

(76) Inventor: Michael Janicki, Richmond (CA)

Correspondence Address: Hollingsworth & Funk, LLC, Suite 125, 8009 34th Avenue South, Minneapolis, MN, 55425, US

(21) Appl. No.: 12/407,575

(22) Filed: Mar. 19, 2009

(51) Int. Cl. G06T 1/00; G09G 3/00

(52) U.S. Cl. 345/522; 345/32

(57) ABSTRACT

Three-dimensional visualization in mobile devices involves receiving first and second images at an apparatus. A first and second set of electronically controlled display pixels are caused to independently display the first and second images. The light of the pixels is refracted to cause the first and the second images to be delivered to different focus points to present a three-dimensional image to a viewer.

### TECHNICAL FIELD

This specification relates in general to digital visualization, and more particularly to systems, apparatuses, computer programs, and methods for three-dimensional visualization in mobile devices.

### BACKGROUND

Displays have become recently become all but indispensible on mobile devices. Early mobile phones could do without a display at all, merely needing buttons and switches for user inputs, and a speaker for output (e.g., tones). However, adding even a simple segmented liquid crystal diode display made a big difference in user experience with such devices. For example, a simple display with eight-segment numerals allowed a user to see a number of an incoming caller, show numbers as dialed to catch dialing mistakes, allow retrieval of stored number, allow traversal of menus, etc.

Modern mobile devices are being provided with an ever-widening variety of capabilities. As a result, a general-purpose (e.g., pixel-based) video display has become nearly obligatory on many such devices. Even inexpensive devices, such as digital music players and low-end cell phones, commonly include a color, pixel-based, display. Mobile displays are typically low cost, but have been enhanced to increase ruggedness and energy efficiency. Even though these displays are relatively simple and inexpensive, they can sometimes display colors and resolutions that rival those on desktop computers of 10-15 years ago, albeit using a smaller display area.

### SUMMARY

The present specification discloses systems, apparatuses, computer programs, data structures, and methods for three-dimensional visualization in mobile devices. In one embodiment, a method involves receiving first and second images at an apparatus. A first and second set of electronically controlled display pixels are caused to independently display the first and second images. The light of the pixels is refracted to cause the first and the second images to be delivered to different focus points to present a three-dimensional image to a viewer.

In more particular embodiments, causing the first and second set of electronically controlled display pixels to independently display the first and second images involves displaying adjacent pixel columns alternatively belonging to the first and second sets of display pixels. In such a case, refracting the light of the pixels may involve disposing a lens assembly over the pixel columns that refracts light uniformly along each of the pixel columns. The lens assembly refracts light from the pixel columns of the first set in a first direction and refracts light from the pixel columns of the second set in a second direction.

In another more particular embodiment, causing the first and second set of electronically controlled display pixels to independently display the first and second images involves displaying a checkerboard pattern formed by alternating ones of pixels from the first and second sets of display pixels. In such a case, refracting the light of the pixels may involve disposing a lens assembly having a lens for each of the display pixels over the display pixels. The first set of display pixels are refracted in a first direction, and the second set of display pixels are refracted in a second direction.

In another more particular embodiment, the first and second images are selectably made substantially identical so that a two-dimensional image having the same resolution of the three-dimensional image is delivered to the binocular viewer. In yet another more particular embodiment, the refracting of the light of the pixels is selectably alterable to present a two-dimensional image having the twice the resolution of the three-dimensional image. In such a case, selectably altering refracting of the light of the pixels may involve removing a lens assembly from the apparatus.

In another embodiment of the invention, an apparatus includes a display having a first and second set of electronically controlled display pixels capable of independently displaying first and second images. The display also includes a focusing device causing the first and the second images to be delivered to different focus points to create a three-dimensional image to a viewer. A processor is coupled to the display. The processor is configured with executable instructions that cause the apparatus to receive the first and second images and cause the images to be displayed in the first and second set of display pixels.

In a more particular embodiment, the display includes adjacent pixel columns alternatively belonging to the first and second sets of display pixels. In such a case, the focusing device may include a lens assembly that refracts light uniformly along each of the pixel columns. The lens assembly refracts light from the pixel columns of the first set in a first direction and refracts light from the pixel columns of the second set in a second direction.

In another more particular embodiment, the display comprises alternating ones of pixels from the first and second sets of display pixels in a checkerboard pattern. In such a case, the focusing device may include a lens assembly having a lens for each of the display pixels. The first set of display pixels are refracted by the lens assembly in a first direction, and the second set of display pixels are refracted by the lens assembly in a second direction.

In another more particular embodiment, the display presents a two-dimensional image having the same resolution of the three-dimensional image if the first and second images are substantially identical.

In another more particular embodiment, the focusing device is adjustable so that the first and second images are refracted in the same direction. In such a case, the display presents a two-dimensional image having the twice the resolution of the three-dimensional image when the focusing device is so adjusted. Also in such a case, the focusing device may be user removable.

In another more particular embodiment, the apparatus includes a head wearable display unit, and wherein the processor causes the apparatus to receive the first and second images from an external mobile device. In such a case, the focusing device may include a first and second display element each respectively comprising the first and second set of display pixels. The first and second display elements are respectively positioned in front of a viewer's left and right eye.

These and various other advantages and features are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments of the invention.

### BRIEF DESCRIPTION OF THE DRAWINGS

The invention is described in connection with example embodiments illustrated in the following diagrams.

FIG. 1A is a perspective view of an apparatus according to an example embodiment of the invention;

FIGS. 1B-C are top and side views of a display device according to an example embodiment of the invention;

FIG. 2A is a top view of a display device according to another example embodiment of the invention

FIG. 2B is a perspective view of an external 3-D viewer according to an example embodiment of the invention;

FIG. 3 is a block diagram of a mobile apparatus according to an example embodiment of the invention; and

FIG. 4 is a flowchart illustrating procedures according to example embodiments of the invention

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

Generally, the present disclosure is related to using handheld display technology, to view three-dimensional (3-D) images such as still images or video. For example, a mobile device may be equipped with a 3-D display that enables a viewer to experience two-dimensional (2-D) and 3-D visualization of content and/or user interface elements. In another example, the mobile device may be configured to drive external display devices to show 3-D content and/or 3-D user interfaces.

The term “3-D image” as used herein generally refers to any still or dynamic representation of a three-dimensional object using a two-dimensional rendering device. The rendering is perceived in such a way that an observer may not be able tell without other senses (e.g., touch) whether the image is an illusion or an actual, tangible object. The rendering generally uses a technique of delivering slightly different images to each of two eyes of a viewer who has binocular vision, thereby mimicking the way light reflects off of actual objects seen by the viewer. This type of 3-D presentation, therefore, usually involve refracting light waves and can be distinguished from other techniques of simulating three dimensions, such as shading and perspective. Those alternate techniques, while also providing an illusion of depth, can be more easily visually determined to be 2-D renderings by viewers, e.g., by looking at the rendering from slightly different angles.

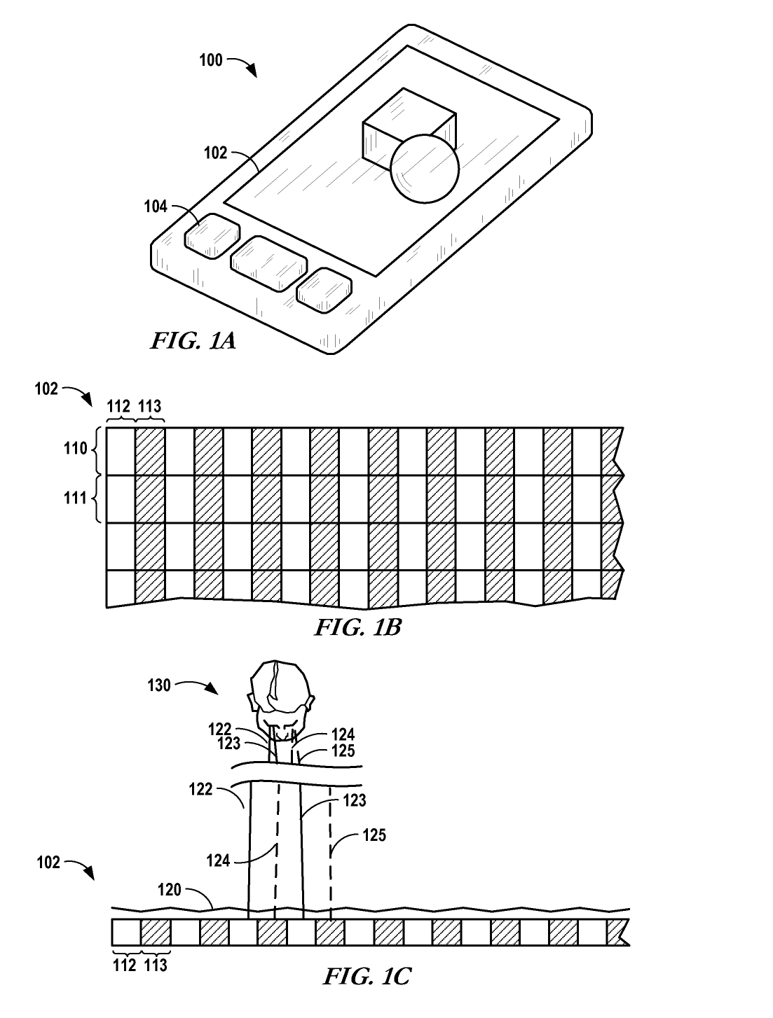

In reference now to FIG. 1, a perspective view shows an apparatus 100 according to an embodiment of the invention. The apparatus 100 includes a display device 102 that has the capability to render 3-D images, e.g., for single user viewing, by delivering slightly different images to both eyes of an observer. The display device 100 may use technologies such as liquid crystal display (LCD), light-emitting diode (LED), organic LED (OLED), electronic ink, etc. The apparatus 100 may include other features associated with such devices, including user input devices 104, processors, memory, wireless/wired data interface, self-contained power supply, etc.

Due to advances mobile device technologies and mobile processor speeds, handheld/portable devices may be able to deliver separate images to each user eye, and give the interpretation of three-dimensional images on mobile devices. This may enhance the potential uses of the devices, such as creating a new market for 3-D images and videos for sharing, and/or 3-D commercial content. Another use of 3-D imaging is providing advances in user interface design by incorporating 3-D components into a user input/output interface, such as a touchscreen interface. Other uses for 3-D displays may be in enhanced mobile e-commerce, such as allowing 3-D previews of products for purchase via the mobile device, e.g., jewelry and watches.

There are various possible ways to deliver separate images on a mobile/handheld apparatus for a 3-D imagery effect, one way being shown in FIGS. 1B-C. In FIG. 1B, a block diagram illustrates a top view (e.g., display surface) of a portion of display device 102. The device 102 generally includes discrete display elements (e.g., pixels) that are shown in FIG. 1B as being arranged in columns and rows. For purposes of further discussion, pixels in representative rows 110, 111 and columns 112, 113 are identified.

In one embodiment, the display may provide two separate images simultaneously interleaved at the pixel level. For example, the display device 102 may display different images in the pixels of columns 112, 113, which are differentiated in the figure by use of shading/hatching in column 113 pixels and no shading/hatching in the column 112 pixels. Thus, two different images are formed by combining the respective shaded and unshaded columns of the display device 102. As is shown in FIG. 1C, these different images can be directed to different eyes to produce a 3-D effect.

In reference now to FIG. 1C, a side view is shown of the display device 102 according to an embodiment of the invention. A lens assembly 120 may be disposed on or near the viewing surface of the display 102. The lens assembly 120 may include a number of individual lenses. For example, the assembly 120 may include lenses oriented over each pixel column (e.g., columns 112, 113) such that the alternating pixels of the respective columns, as represented by lines 122-125 are primarily focused at different angles. In such an embodiment, the lens assembly 120 may refracts light uniformly along each of the pixel columns 112, 113, while refracting light from the pixel column 112 of the first set in a first direction and refracting light from the pixel column 113 of the second set in a second direction.

It will be appreciated that the refraction angles of lines 122-125 in FIG. 1C may be exaggerated in this view, as well as the geometry of the lens assembly 120. Generally, where the lens assembly 120 includes a fixed geometry, the refraction angles may be optimized for some assumed viewing distance. As a result of the refraction caused by the lens assembly 120, images of the hatched pixel columns will be directed along first paths (e.g., paths 124, 125) to be viewed by one eye of a viewer 130, and the images of the unshaded pixel columns will be directed along second paths (e.g., paths 122, 123) to be viewed by the other eye of viewer 130.

It will be appreciated that there are many possible alternative arrangements of the display device 102. For example, instead of or in addition to presenting images on alternating columns, the images could be placed on alternating rows. In such a case, the lens assembly 120 would include the appropriate lenses for the target viewpoints. If the display device 102 included the ability to alternate both columns and rows at the same time, then up to four separate images may be presented at the same time, e.g., one for each of the four pixels at the intersection of rows 110-111 and columns 112-113. The lens assembly 120 in such an example could be configured to diffract the images in four directions instead of two. It will be appreciated that the 3-D effect typically involves delivering a separate image to each horizontally disposed eye (left to right), therefore a vertical refraction of row images (top to bottom) in addition to separation of the column images may not provide any 3-D enhancement. However, where the device 100 includes such a four-directional lens assembly 120 and an orientation sensor, the display 102 may be able to switch between row and column modes. For example, either alternate columns or alternate rows may be combined to form the 3-D view from two separate images depending on device orientation.

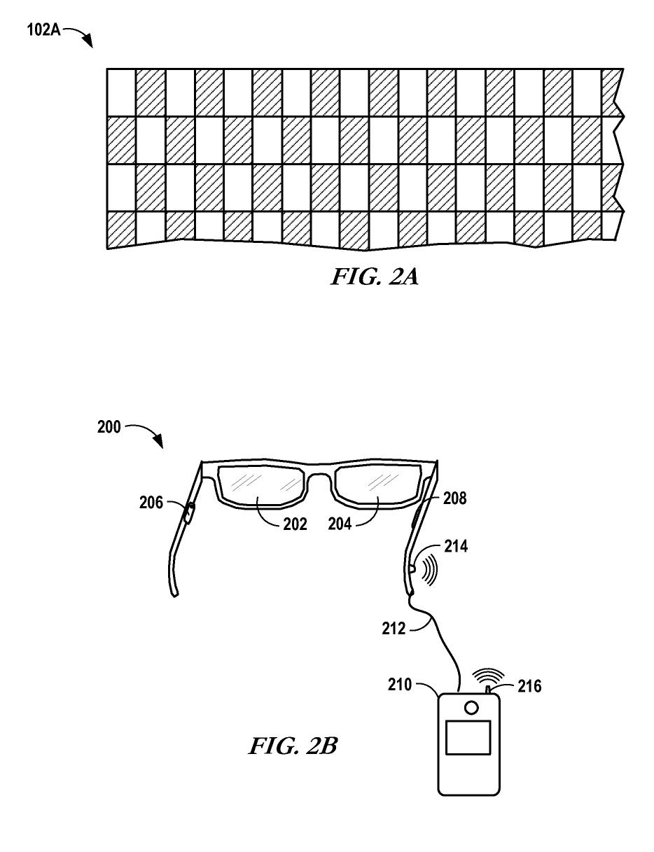

Another example embodiment of the pixel layout in a display 102A is shown in FIG. 2A. This display 102A is adaptable to display two separate images as represented by shaded and unshaded pixels. In this example the shaded and unshaded pixels representing first and second images are staggered in a checkerboard pattern. It will be appreciated that the same emitting/reflecting device (e.g., OLED array) may be used in either illustrated embodiment 102, 102A, as well as other embodiments discussed herein. The various alternating display patterns may be obtained by using different drivers/firmware, as well as different configurations of lens assembly 120. Thus, a mobile device (e.g., device 100) may be adaptable for different display configurations 102, 102A by the use of interchangeable lens assemblies 120 and software/firmware.

It will be appreciated that the display devices 102, 102A may display 2-D images as well. In a 2-D mode, the display 102 could show the same images on shaded and unshaded columns, thus presenting a 2-D image at the same resolution as the 3-D image. A similar result would be seen in 102A, where first and second images formed by shaded and unshaded pixels are identical. In another arrangements, the displays 102, 102A may be able to show a double resolution 2-D image (e.g., using all of the shaded and unshaded pixels for a single image) if the lens assembly 120 can be user removed or otherwise disabled from refracting the light emitted/reflected at the pixels.

The lens assembly 120 may be a fixed optical device that is integrated with the display device 102, 102A during manufacture. In other arrangement, the lens assembly 120 may be user removed/installed, or otherwise adjustably placed (e.g., a pivoting cover). In such a case, the display device 102, 102A or mobile device 100 may include switches or other detectors to determine which lens assembly 120, if any is installed. The devices 100, 102, 102A may then be able to automatically be placed in a certain display mode (e.g., 2-D, 3-D alternating rows, 3-D alternating columns, 3-D checkerboard, etc.) in response to this detection.

In another example, the lens 120 may be capable of being adjusted to affect the angles of refraction to adjust and/or remove the 3-D effect. For example, technologies such as micro-electromechanical systems (MEMS) and piezoelectric transducers may be used to form an adjustable lens assembly. In yet another variation, these same technologies may be used to vary the angle of emission/reflection of the pixels (or pixel columns) themselves, thereby foregoing the need for a lens to refract the emitted/reflected light.

It will be appreciated that 3-D content displayable in the device 102 may include 3-D captures of actual objects, such as via dual cameras. Other 3-D content may include virtual, computer generated content (e.g., still images or videos) that is used to construct the appropriate dual images. An example of computer generated 3-D content may include a 3-D user interface that mimics physical objects, e.g., raised 3-D pushbuttons, readouts to simulate mechanical flip displays or “nixie” tube displays.

In another embodiment, the mobile device 100 using the display device 102 may include features for generating 3-D content. For example, the device 100 may include dual charge coupled detector (CCD) cameras (not shown) spaced so as to generate 3-D images appropriate for the display device 102. In another example, the device 100 may include a single CCD camera (not shown), and include software features that allow the user to correctly compose shots for 3-D viewing. For example, the user may take one photo with the camera, which is shown on one set of alternating set of pixels of the display 102, 102A and the other row/column of pixels displays a video feed from the camera. In such a case, the user moves the device slightly (e.g., left or right) until the image in the display 102, 102A has the desired 3-D appearance, and at that point takes the second shot. Software inside the device 100 can combine the two images into a 3-D image file format usable by the device 100.

In another example, the device 100 may include software (or access such functionality via a network service) having algorithms that can accurately compose a 3-D image based on two shots of the same subject that are separated by an approximate distance/angle sufficient to accurately compose a single 3-D image suitable for display 102, 102A. This frees the user from having to carefully compose shots. In such a case, the apparatus 100 may include accelerometers, position detection, or other sensors that assist the user in taking the first and second shots to at an approximate location that allows for the for a correction algorithm to efficiently work. In such a case, after taking a first shot, the display 102 may show a live video of the camera view with arrows indicating in which direction the user should move in order to take the second shot.

In reference now to FIG. 2B, a perspective view shows a display device 200 for mobile 3-D display according to another embodiment of the invention. The device 200 may include or be attached to eyeglasses having lenses 202, 204 that display two different images to create a 3-D effect. The lenses 202, 204 may be active display elements (e.g., LCD, LED devices) and/or may be transparent eyeglass lenses that have an image projected onto them. In the latter case, projection elements 206, 208 may be mounted on the device 200 in an appropriate location for projecting images onto the lenses 202, 204.

The viewing device 200 may be driven by any type of electronic device, here shown as mobile device 210. The mobile device 210 may communicate with the viewing device 200 via a wired interface 212 and/or wireless interface, as represented by antennas 214, 216. The viewing device 200 may display dual images on the lenses 202, 204 either using its own processor and/or be driven by mobile device 210. In one embodiment, the device 210 may display different images simultaneously on lenses 202, 204, e.g., by using two video channels each dedicated to one of the lenses 202, 204. In another embodiment, the devices 200 and/or 210 may shutter which image is displayed at a particular time. For example, image1 may be presented for a very brief moment in lens 202 and block viewing at lens 204 (or retain a previously buffered image in lens 204) and then subsequently display image2 in lens 204 while blocking or holding the image in lens 202. The shuttering rate in such a case would generally need to be fast enough to not be perceived by the user. As with device 102 in FIGS. 1A-C, the viewing device 200 can be used for displaying 2-D and/or 3-D images/video, and may be adapted for use with content creation features of device 210 (e.g., single or dual cameras) as described in relation to FIGS. 1A-C.

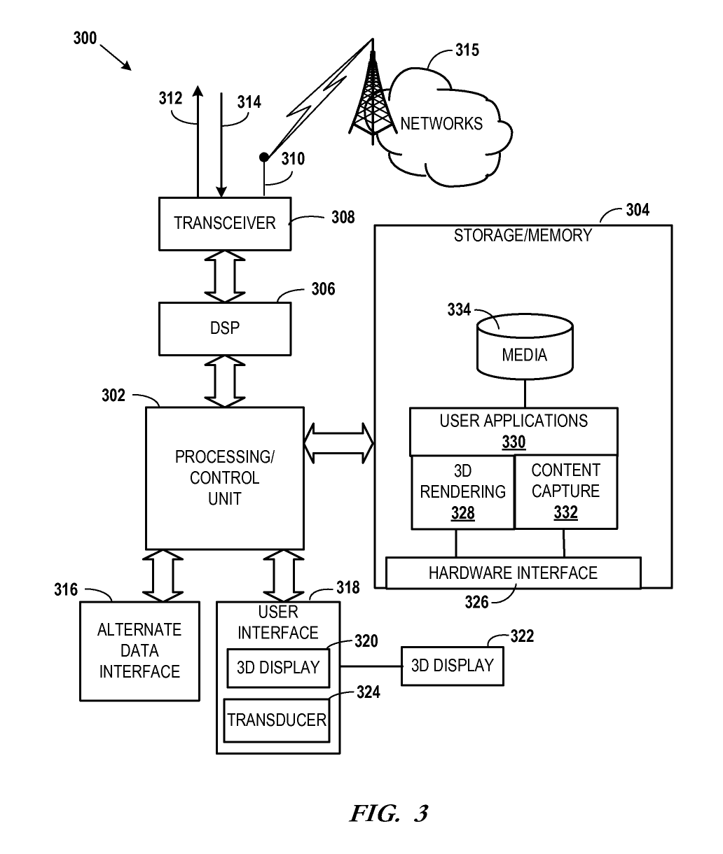

Many types of apparatuses may be used for 3-D viewing applications as described herein. For example, users are increasingly using mobile communications devices (e.g., cellular phones) as multipurpose mobile computing devices. In reference now to FIG. 3, an example embodiment is illustrated of a representative mobile apparatus 300 capable of carrying out operations in accordance with example embodiments of the invention. Those skilled in the art will appreciate that the example apparatus 300 is merely representative of general functions that may be associated with such devices, and also that fixed computing systems similarly include computing circuitry to perform such operations.

The user apparatus 300 may include, for example, a mobile apparatus, mobile phone, mobile communication device, mobile computer, laptop computer, desk top computer, phone device, video phone, conference phone, television apparatus, digital video recorder (DVR), set-top box (STB), radio apparatus, audio/video player, game device, positioning device, digital camera/camcorder, and/or the like, or any combination thereof Further the user apparatus 300 may include features of the display devices and mobile apparatuses shown in FIGS. 1A-C and 2A-B.

The processing unit 302 controls the basic functions of the apparatus 300. Those functions associated may be included as instructions stored in a program storage/memory 304. In an example embodiment of the invention, the program modules associated with the storage/memory 304 are stored in non-volatile electrically-erasable, programmable read-only memory (EEPROM), flash read-only memory (ROM), hard-drive, etc. so that the information is not lost upon power down of the mobile terminal. The relevant software for carrying out operations in accordance with the present invention may also be provided via computer program product, computer-readable medium, and/or be transmitted to the mobile apparatus 300 via data signals (e.g., downloaded electronically via one or more networks, such as the Internet and intermediate wireless networks).

The mobile apparatus 300 may include hardware and software components coupled to the processing/control unit 302. The mobile apparatus 300 may include multiple network interfaces for maintaining any combination of wired or wireless data connections. The illustrated mobile apparatus 300 includes wireless data transmission circuitry for performing network data exchanges. This wireless circuitry includes a digital signal processor (DSP) 306 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 308, generally coupled to an antenna 310, transmits the outgoing radio signals 312 and receives the incoming radio signals 314 associated with the wireless device. These components may enable the apparatus 300 to join in one or more communication networks 315, including mobile service provider networks, local networks, and public networks such as the Internet and the Public Switched Telephone Network (PSTN).

The mobile apparatus 300 may also include an alternate network/data interface 316 coupled to the processing/control unit 302. The alternate data interface 316 may include the ability to communicate via secondary data paths using any manner of data transmission medium, including wired and wireless mediums. Examples of alternate data interfaces 316 include USB, Bluetooth, RFID, Ethernet, 302.11 Wi-Fi, IRDA, Ultra Wide Band, WiBree, GPS, etc. These alternate interfaces 316 may also be capable of communicating via the networks 315, or via direct and/or peer-to-peer communications links.

The processor 302 is also coupled to user-interface hardware 318 associated with the mobile terminal. The user-interface 318 of the mobile terminal may include, for example, an integrated 3-D display 320 such as such as shown and described in relation to FIGS. 1A-C and 2A. The 3-D display 320 may be coupled to processor 302 via input-output interfaces as known in the art, and the display 320 may be controlled via software as described in greater detail below. The hardware 318 may also include physical, electrical, and software interfaces for utilizing external 3-D display 322, e.g., display as shown and described in relation to FIG. 2B.

The user-interface hardware 318 also may include a transducer 324, such as an input device capable of receiving user inputs. The transducer 324 may also include sensing devices capable of measuring local conditions (e.g., location temperature, acceleration, orientation, proximity, etc.) and producing media (e.g., text, still pictures, video, sound, etc). Other user-interface hardware/software may be included in the interface 318, such as keypads, speakers, microphones, voice commands, switches, touch pad/screen, pointing devices, trackball, joystick, vibration generators, lights, accelerometers, etc. These and other user-interface components are coupled to the processor 302 as is known in the art.

The program storage/memory 304 includes operating systems for carrying out functions and applications associated with functions on the mobile apparatus 300. The program storage 304 may include one or more of read-only memory (ROM), flash ROM, programmable and/or erasable ROM, random access memory (RAM), subscriber interface module (SIM), wireless interface module (WIM), smart card, hard drive, computer program product, or other removable memory device. The storage/memory 304 may also include one or more hardware interfaces 323. The interfaces 323 may include any combination of operating system drivers, middleware, hardware abstraction layers, protocol stacks, and other software that facilitates accessing hardware such as user interface 318, alternate interface 3 16, and network hardware 306, 308.

The storage/memory 304 of the mobile apparatus 300 may also include specialized software modules for performing functions according to example embodiments of the present invention. For example, the program storage/memory 304 includes a hardware interface 326 that includes drivers for generating signals to display 3-D content on display(s) 320, 322. For example, the signals cause 3-D images to be displayed by shuttering (or otherwise distributing) two or more images between first and second sets of pixels of the display 320, 322. A 3-D rendering module 328 may provide application-level functions for receiving 3-D data and preparing it for rendering via drivers 326. The rendering module 326 may be able to receive previously rendered data (e.g., digital photos/videos) and/or receive geometry data (e.g., vectors), and other rendering data (e.g., texture bitmaps). In the latter case, the rendering module may use known algorithm to render the imagery as 3-D video or still image data suitable for processing by the drivers 326.

The memory 304 may also include user applications 330 that provide 3-D-specific features. For example, the applications 330 may provide access to data storage 334 that contains 3-D content. The applications 330 may include network programs for obtaining 3-D visual content from networks 315 and/or utilize network services for processor intensive pre-processing for creating user content. The applications 330 may also include user programs that facilitate 3-D content creation via the apparatus 300 for display on output device(s) 320, 322 on this and other user apparatus.

In order to facilitate user creation of 3-D content, the memory 304 may include capture module 332 for obtaining data via user interface hardware 318 (e.g., cameras). The capture module 332 may obtain other sensor data (e.g., accelerometer data) and use it to assist in content creation. For example, an accelerometer output may be obtained by the capture module 332 and used to guide the user in positioning the apparatus 300 to take multiple pictures from different viewpoints so that these images may be merged into a single 3-D rendering. Such measured data received by the content capture module 332 may also be used to modify presentation of 3-D imagery. For example, a display device 320, 322 may be capable of providing separate left/right images from both horizontal and vertical orientations of the apparatus 300, and the rendering module 330 and drivers 326 may utilize the accelerometer data received from capture module 332 to trigger this transition.

The mobile apparatus 300 of FIG. 3 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

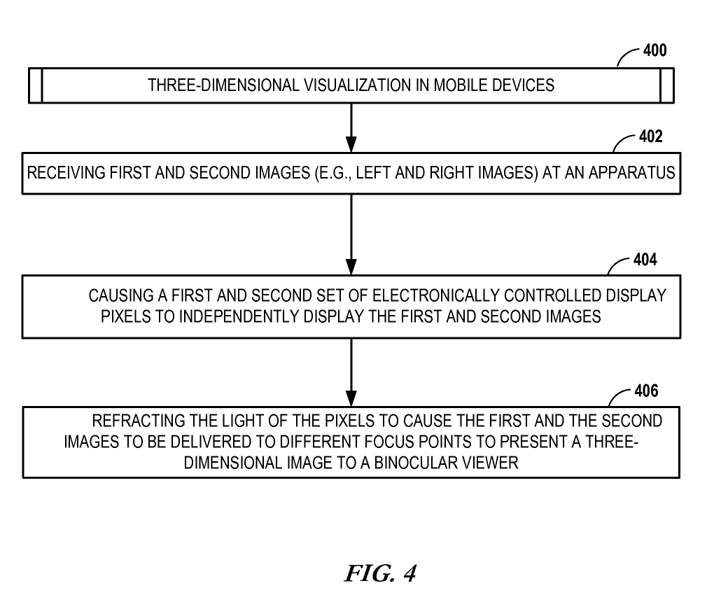

In reference now to FIG. 4, a flowchart illustrates a procedure 400 for three-dimensional visualization in mobile devices according to an example embodiment of the invention. The procedure involves receiving 402 first and second images at an apparatus. For example, the first and second images may include a left and right version of a composite 3-D image. A first and second set of electronically controlled display pixels are caused 404 to independently display the first and second images. The pixels of the first set may be substantially adjacent to pixels of the second set, e.g., in an alternating column format, alternating pixel format (checkerboard), etc. In other arrangements, the pixels may be part of display elements dedicated to each eye of the viewer (e.g., wearable eyeglass display). The light of the pixels is refracted 406 to cause the first and the second images to be delivered to different focus points to present a three-dimensional image to a binocular viewer.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus, comprising:
a display comprising:
a first and second set of electronically controlled display pixels capable of independently displaying first and second images; and
a focusing device causing the first and the second images to be delivered to different focus points to create a three-dimensional image to a viewer;
a processor coupled to the display, wherein the processor is configured with executable instructions that cause the apparatus to receive the first and second images and cause the images to be displayed in the first and second set of display pixels.

2. The apparatus of claim 1, wherein the display comprises adjacent pixel columns alternatively belonging to the first and second sets of display pixels.

3. The apparatus of claim 2, wherein the focusing device comprises a lens assembly that refracts light uniformly along each of the pixel columns, wherein the lens assembly refracts light from the pixel columns of the first set in a first direction and refracts light from the pixel columns of the second set in a second direction.

4. The apparatus of claim 1, wherein the display comprises alternating ones of pixels from the first and second sets of display pixels in a checkerboard pattern.

5. The apparatus of claim 4, wherein the focusing device comprises a lens assembly having a lens for each of the display pixels, wherein the first set of display pixels are refracted in a first direction, and wherein the second set of display pixels are refracted in a second direction.

6. The apparatus of claim 1, wherein the display presents a two-dimensional image having the same resolution of the three-dimensional image if the first and second images are substantially identical.

7. The apparatus of claim 1, wherein the focusing device is adjustable so that the first and second images are refracted in the same direction, and wherein the display presents a two-dimensional image having the twice the resolution of the three-dimensional image when the focusing device is so adjusted.

8. The apparatus of claim 7, wherein the focusing device is user removable.

9. The apparatus of claim 1, wherein the apparatus comprises a head wearable display unit, and wherein the processor causes the apparatus to receive the first and second images from an external mobile device.

10. The apparatus of claim 9, wherein the focusing device comprises a first and second display element each respectively comprising the first and second set of display pixels, wherein the first and second display elements are respectively positioned in front of a viewer's left and right eye.

11. A method, comprising:
receiving first and second images at an apparatus;
causing a first and second set of electronically controlled display pixels to independently display the first and second images; and
refracting the light of the pixels to cause the first and the second images to be delivered to different focus points to present a three-dimensional image to a viewer.

12. The method of claim 11, wherein causing the first and second set of electronically controlled display pixels to independently display the first and second images comprises displaying adjacent pixel columns alternatively belonging to the first and second sets of display pixels.

13. The method of claim 12, wherein refracting the light of the pixels comprises disposing a lens assembly over the pixel columns that refracts light uniformly along each of the pixel columns, wherein the lens assembly refracts light from the pixel columns of the first set in a first direction and refracts light from the pixel columns of the second set in a second direction.

14. The method of claim 11, wherein causing the first and second set of electronically controlled display pixels to independently display the first and second images comprises displaying a checkerboard pattern formed by alternating ones of pixels from the first and second sets of display pixels.

15. The method of claim 14, wherein refracting the light of the pixels comprises disposing a lens assembly having a lens for each of the display pixels over the display pixels, wherein the first set of display pixels are refracted in a first direction, and the second set of display pixels are refracted in a second direction.

16. The method of claim 11, wherein the first and second images are selectably made substantially identical so that a two-dimensional image having the same resolution of the three-dimensional image is delivered to the binocular viewer.

17. The method of claim 11, wherein the refracting of the light of the pixels is selectably alterable to present a two-dimensional image having the twice the resolution of the three-dimensional image.

18. The method of claim 17, wherein selectably altering refracting of the light of the pixels comprises removing a lens assembly from the apparatus.
